(19) United States
(12) Patent Application Publication
(10) Pub. No.: US 2005/0088386 A1
(43) Pub. Date: Apr. 28, 2005

(54) [LIQUID CRYSTAL DISPLAY PANEL AND DRIVING CIRCUIT THEREOF]

(76) Inventors: Chien-Hsien Kao, Taipei City (TW); Alex Tang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,459

(22) Filed: Dec. 16, 2003

(30) Foreign Application Priority Data
Oct. 28, 2003 (TW) 92129874

(51) Int. Cl. G09G 3/36; H04N 7/18; H04N 9/47

(52) U.S. Cl. 345/87

(57) ABSTRACT

A liquid crystal display (LCD) panel and driving circuit having a high response speed is provided. The LC panel at least includes a first group of gate lines, a second group of gate lines, and a first group of source lines, in which gate pulse signals can be fed to the LCD panel through the two groups of gate lines. Preferably, the LC panel further includes a second group of source lines, in which one of the two groups of source lines can be fed with the image data, and the other one is fed with a black image data. Accordingly, the LCD panel can only use the twisted nematic LC or the vertical alignment LC (VA-LC), without need of optically compensated birefringent LC (OCB-LC). Thus, the problems of a fast response speed LC panel using an OCB-LC can be avoided.

### CROSS REFERENCE TO RELATED APPLICATIONS

This application claims the priority benefit of Taiwan application No. 92129874, filed on Oct. 28, 2003.

### BACKGROUND OF INVENTION

1. Field of Invention

The present invention relates to liquid crystal display (LCD) panel and the driving circuit. More particularly, the present invention relates to the LCD panel and the driving circuit with fast response speed.

2. Description of Related Art

The conventional driving device for the LCD panel, in general, has the structure as shown in FIG. 1. The conventional LCD panel includes a liquid crystal (LC) panel 102, a gate driver 104 used to activate the gate lines G1, G2, . . . Gn of the LC panel 102, and a source driver 106 used to activate the source lines S1, S2, . . . Sm. Usually, if the response speed is not sufficiently fast, the image for a fast motion cannot response in time, in which the image and text cannot be well discerned. This is known as the image lagging phenomenon. The response time is the essential factor, wherein the concerning issue is the response speed of the LCD panel with respect to the input signals, that is, the needed action time for the LCD panel to change from bright to dark or from dark to bright, or gray to gray. In general, the response time in TFT-LCD panel specification includes two parts, in which one is the rising time (Tr) and another is the falling time (Tf), and the response time is the sum of these two types of time. When the response time is smaller, the response speed is faster. If the response time is over 40 ms, then the image lagging for the motion object would occur. Currently, the LCD panel has the standard response time usually less than about 25 ms, in which a few of the LCD panels can be less than 16 ms.

In order to solve the foregoing issue, during developing the fast LCD panel, a manner by inserting a black image is used, so as to effectively trigger the visual effect by eye, and the image lagging phenomenon can be reduced. The convention method to insert the black image needs to insert a black image in a frame period, resulting in the consumption of the frame time. This causes that the response time of the conventional LCD panel is relatively insufficiently short. In order to solve this issue, it needs to use the optically compensated birefringent (OCB) liquid crystal in fast response, so as to reduce the displaying time in a frame. The OCB liquid crystal is a special liquid crystal with the display cell structure. Since the OCB liquid crystal is necessary to be pre-converted form the splay state to the bend state in driving the OCB liquid crystal, so as to be continuously driven and produce the gray level. Therefore, the driving method is more complicate than the usual twisted nematic (TN) liquid crystal. In the OCB liquid crystal, it is also necessary to raise the output frequency of the source driving circuit, in which is usually needs to be over 80 KHz while the conventional TN LCD panel is only 48 KHz. In addition, the back light module needs to associate with the time sequence, so as to insert the black image.

In order to solve the foregoing specific issues about needing use of the OCB liquid crystal during the development of the fast-speed LCD panel, needing high driving frequency while the OCB liquid crystal is used, and needing to increase a controller on the back light module to produce the black image. Then, it is necessary to have the driving circuit with the function to improve the response speed of the LCD panel.

### SUMMARY OF INVENTION

The invention provides an LCD panel with increased response time.

The invention provides a driving circuit for increasing the response time of an LCD panel.

The invention provides an LCD panel, which at least includes a first group of gate lines, a second group of gate lines, and a first group of source lines, in which gate pulse signals can be fed to the LCD panel through the two groups of gate lines.

Preferably, in the foregoing LC panel, the first group of gate lines can be used to feed gate pulses of an actual image data and the second group of gate lines can be used to feed gate pulses of a black image data. Alternatively, the first group of gate lines can be used to feed gate pulses of a black image data and the second group of gate lines can be used to feed gate pulses of an actual image data. Wherein, a time difference between the first group of gate lines and the second group of gate lines being fed the gate pulses is a time period of one horizon line or several horizontal lines.

Preferably, in the foregoing LCD panel, the first group of gate lines and the second group of gate lines are at the same side or at the different side.

Preferably, in the foregoing LCD panel, it further includes a second group of source lines. Wherein, the first group of source lines can be fed with the source actual image data, and the other one is fed with a source black image data. Alternatively, the first group of source lines can be fed with the source black image data, and the other one is fed with a source actual image data. Wherein, a time difference between the first group of source lines and the second group of source lines being fed data is a time period of one horizon line or several horizontal lines.

The present invention also provides a driving device for a liquid crystal display, at least including an LC panel, a first gate driver having a first group of gate lines coupled to the LC panel, a second gate driver having a second group of gate lines coupled to the LC panel, and a first source driver having a first group of source lines coupled to the LC panel.

Preferably, in the foregoing driving device for the LCD, the first group of gate lines is used to feed gate pulses of an actual image, and the second group of gate lines is used to feed gate pulses of a black image data. Alternatively, the first group of gate lines is used to feed gate pulses of a black image, and the second group of gate lines is used to feed gate pulses of an actual image data. Wherein, a time difference between the first group of gate lines and the second group of gate lines being fed the gate pulses is a time period of one horizon line or several horizontal lines.

Preferably, in the foregoing driving device for the LCD, each of the first group of gate lines and the second group of gate lines further includes a shift register receiving an input data, a level shifter coupled to the shift register, and an output buffer coupled to level shifter and the corresponding group of gate lines. Wherein, the first gate driver and the second gate driver can be implemented at the same side or different sides. Wherein, when the first gate driver and the second gate driver are at the same side, the first gate driver and the second gate driver can be the same diver or different drivers.

Preferably, in the foregoing driving device for the LCD, it further includes a second source driver having a second group of source lines coupled to the LC panel. Wherein, the first group of source lines is used to feed with a source actual image data, and the second group of source lines is used to feed with a source black image data. Alternatively, the first group of source lines is used to feed with a source black image data, and the second group of source lines is used to feed with a source actual image data. Wherein, a time difference between the first group of source lines and the second group of source lines being fed data is a time period of one horizon line or several horizontal lines.

Preferably, in the foregoing driving device for the LCD, each of the first source driver and the second source driver further includes a DAC coupled to an analog input data, and a output buffer coupled to the DAC and the corresponding source lines in the group. Wherein, the first source driver and the second source driver can be implemented at the same side or different sides. Wherein, when the first source driver and the second source driver are at the same side, the first source driver and the second source driver can be the same diver or different drivers.

In the foregoing descriptions, the driving circuit for the LCD panel with fast response speed in the invention can only use the TN or vertical alignment (VA) LC, without using the OCB LC as the LC panel. This can solve the conventional issues of using the OCB LC, which further causes an over-high of driving frequency and needs to preconvert the OCB LC from the splay state to the bend state, so as to continuously producing the gray level, and needs a controller of the back light module to have the control between the actual image data and the black image data. The fabrication cost, production cycle, complicity of the LCD, and so on can be effectively reduced.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a drawing, schematically illustrating a conventional TFT-LCD panel structure.

FIG. 2 is a drawing, schematically an LCD panel with the drivers, according to a preferred embodiment of the invention.

FIG. 3 is a drawing, schematically illustrating an LCD panel with the drivers, according to another preferred embodiment of the invention.

FIGS. 4A-4B is a drawing, schematically illustrating a driving circuit on an LCD panel, according to a preferred embodiment of the invention.

FIGS. 5A-5B is a drawing, schematically illustrating a driving circuit on an LCD panel, according to another preferred embodiment of the invention.

FIG. 6 is a drawing, schematically illustrating the output signals of the gate driver, according to a preferred embodiment of the invention.

FIG. 7 is a drawing, schematically illustrating a scanning status for an image frame of the LCD panel, according to a preferred embodiment of the invention.

FIG. 8 is a block drawing, schematically illustrating the gate driver, according to a preferred embodiment of the invention.

FIG. 9 is a block drawing, schematically illustrating the source driver, according to a preferred embodiment of the invention.

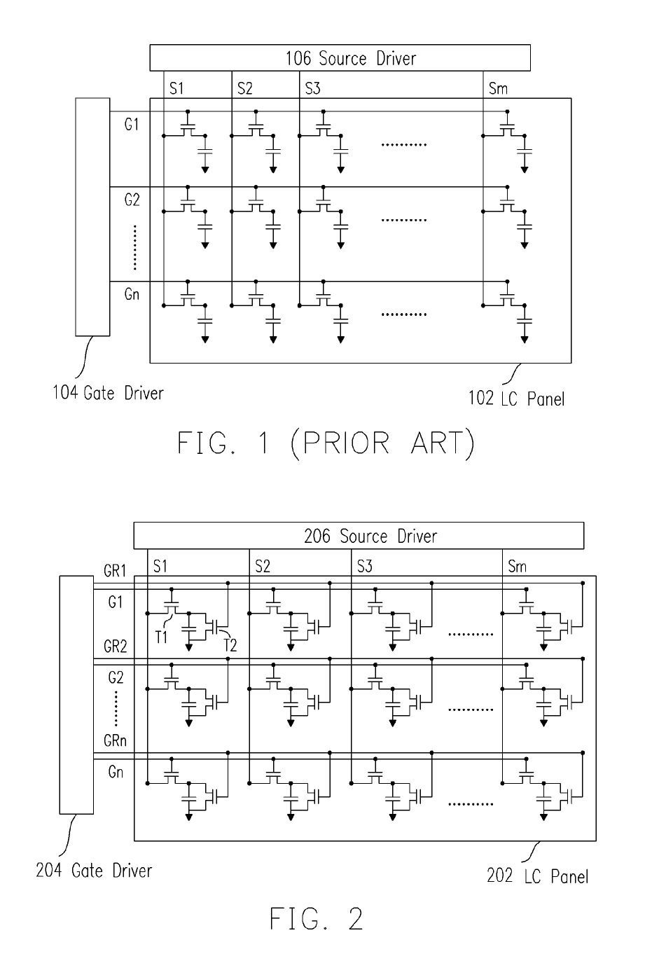

### DETAILED DESCRIPTION

In the following descriptions, FIG. 2 is a drawing, schematically an LCD panel with the drivers, according to a preferred embodiment of the invention.

In FIG. 2, an LC panel 202 with the driving circuit is provided and is suitable for use on a normally black panel. It includes a first group of gate lines from G1 to Gn, and a second group of gate lines from GR1 to GRn, and a first group of source lines from S1 to Sm. Wherein, the first group of gate lines from G1 to Gn is coupled to the gate electrodes of the first group of transistors T1, which serving as the switching function for data scan of the LC panel 202. The second group of gate lines from GR1 to GRn is coupled to the gate electrodes of the second group of transistors T2. Wherein, the transistors T1 and T2 includes thin film transistor (TFT).

In the foregoing embodiment, the first group of gate lines from G1 to Gn and the second group of gate lines from GR1 to GRn can be used to feed with gate pulse signals to the LC panel 202. For example, when the first group of gate lines from G1 to Gn is fed with the gate pulse signals of an actual image, the second group of gate lines from GR1 to GRn is fed with gate pulse signals of a black image. In this situation, a black image can be inserted after at least one horizontal line, or several horizontal lines. Alternatively, when the first group of gate lines from G1 to Gn is fed with the gate pulse signals of a black image, the second group of gate lines from GR1 to GRn is fed with gate pulse signals of an actual image. The effect is similar.

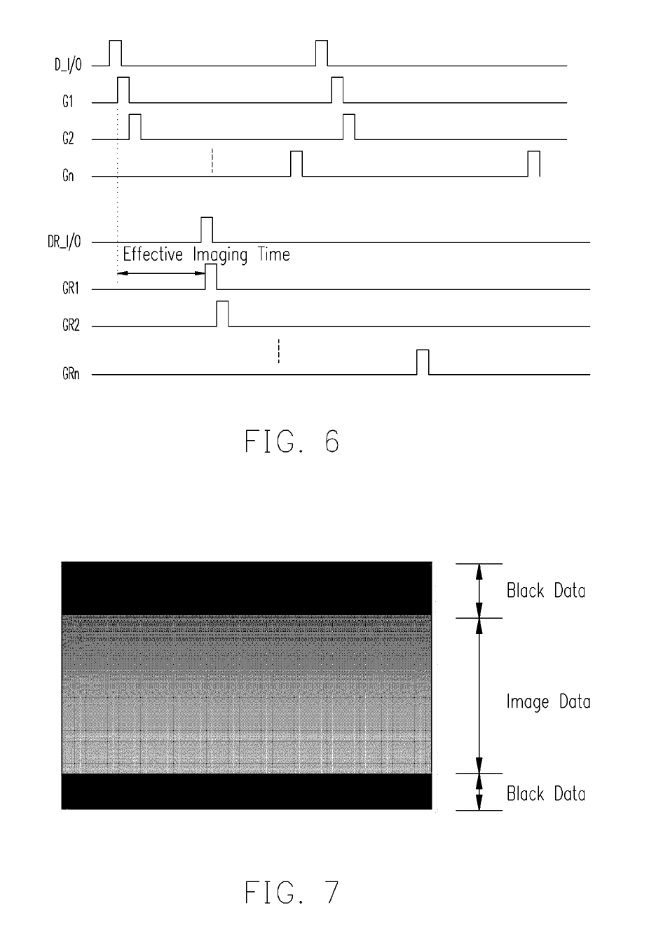

In FIG. 2, a gate driver 204 and a source driver 206 can be further included. In this manner, by using the sequence I/O of the two groups of gate drivers, D_I/O and DR_I/O, it can be achieved to have interlacing scan on the image. The two groups of sequence signals D_I/O and DR_I/O can be simultaneously obtained from the sequence controller, or one of them is obtained by the internal counting from the gate driver 204. Using the two sequence signals D_I/O and DR_I/O being fed to the gate diver 204, the pulse signals are generated and exported to first group of gate lines G1 to Gn, and the second group of gate lines GR1 to GRn, so as to drive the LCD panel. Referring to FIG. 6, it is a drawing, schematically illustrating the output signals of the gate driver, according to a preferred embodiment of the invention. For example, after the sequence signals D_I/O are fed to the gate driver 204, the gate pulse signals are generated in sequence and are fed to the first group of gate lines G1 to Gn, wherein the state of up/down (U/D) for input control of the gate driver is U/D=1. At this moment, the actual image data from the source driver 206 are exported to the pixels of the scanned line. At a period of time after the sequence signals D_I/O have been fed, the sequence signal DR_I/O are fed to the gate driver 204. The gate pulse signals for the black image data with respect to the second group of gate lines GR1 to GRn are sequentially generated and exported to the second group of gate lines GR1 to GRn, wherein the gate driver is at the state of U/D=1. As shown in FIG. 6, the scanning pulses of the actual image data and the black image data relatively has a time difference. This time difference is called as the effective imaging time of the horizontal line. The quantity of the effective imaging time is depending on the impulse response of the human eye.

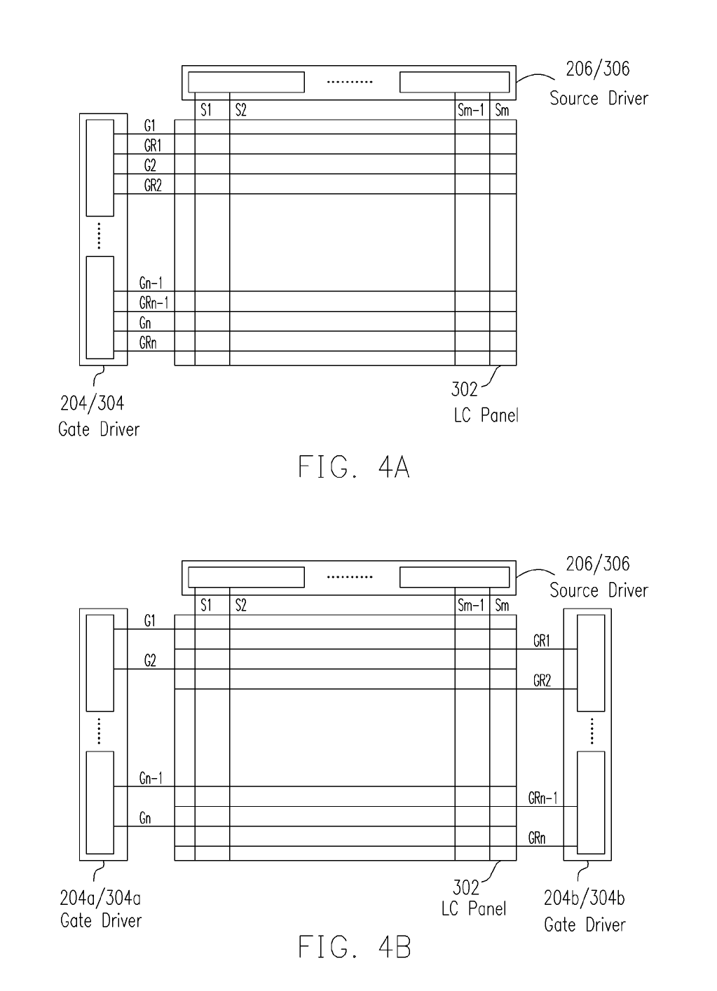

FIGS. 4A-4B is a drawing, schematically illustrating a driving circuit on an LCD panel, according to a preferred embodiment of the invention. When the gate drivers 204 for the first group of gate lines G1 to Gn and the second group of gate lines GR1 to GRn are at the same side of the LC panel, the structure is shown in FIG. 4A. Alternatively, when the first gate driver 204a of the first group of gate lines G1 to Gn, and the second gate driver 204b of the second group of gate lines GR1 to GRn are at different sides, the structure is shown in FIG. 4B. The sequence signals D_I/O are fed to the gate driver 204a, and the sequence signals DR_I/O are fed to the gate driver 204b, then pulse signals are generated and fed to the first group of gate lines G1 to Gn and the second group of gate lines GR1 to GRn. The results are similar to the results in FIG. 4A. FIG. 7 is a drawing, schematically illustrating a scanning status for an image frame of the LCD panel, according to a preferred embodiment of the invention. In FIG. 7, the scanned result at the middle region of time is from the output of the actual image being scanned from top to bottom, and scanned result at the front and the post regions is the output of the black image being also scanned together with the actual image from top to bottom. In other words, the output of black image can last for a time period of one horizontal line, several horizontal lines, or the whole image, or even more. For all of the gate drivers, the scanning direction can be from the top part to the bottom part, or from bottom part to top part.

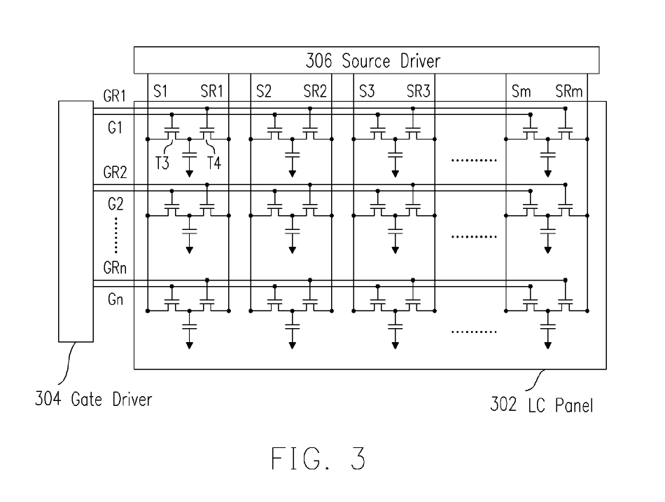

In the following descriptions, FIG. 3 is a drawing, schematically illustrating an LCD panel with the drivers, according to another preferred embodiment of the invention.

In FIG. 3, an LC panel 302 with the driving circuit is provided, and is suitable for use on a normally white panel or a normally black panel. It includes a first group of gate lines G1 to Gn, a second group of gate lines GR1 to GRn, a first group of source lines S1 to Sm, and a second group of source lines SR1 to SRm. Wherein, the first group of gate lines G1 to Gn is coupled to the gate electrodes of the first group of transistors T3 of the LC panel 302 for driving use. The second group of gate lines GR1 to GRn is coupled to the gate electrodes of the second group of transistors T4, wherein the transistors T3 and T4 include TFT.

In the foregoing embodiment, at least one of the first group of gate lines G1 to Gn and the second group of gate lines GR1 to GRn can be used to feed pulse signals to the LC panel 302. For example, when the first group of gate lines from G1 to Gn is fed with the gate pulse signals of an actual image, the second group of gate lines from GR1 to GRn is fed with gate pulse signals of a black image. In this situation, a black image can be inserted after at least one horizontal line, or several horizontal lines. Alternatively, when the first group of gate lines from G1 to Gn is fed with the gate pulse signals of a black image, the second group of gate lines from GR1 to GRn is fed with gate pulse signals of an actual image. The effect is similar.

In FIG. 3, the embodiment can further include a gate driver 304 and a source driver 306. In this situation, by using two groups of sequence signals D_I/O and DR_I/O, it can be achieved to have interlacing scan on the image. The two groups of sequence signals D_I/O and DR_I/O can be simultaneously obtained from the sequence controller, or one of them is obtained by the internal counting from the gate driver 304. Using the two groups of sequence signals D_I/O and DR_I/O being fed to the gate diver 304, the pulse signals are generated and exported to first group of gate lines G1 to Gn, and the second group of gate lines GR1 to GRn, so as to drive the LCD panel. Referring to FIG. 6, it is a drawing, schematically illustrating the output signals of the gate driver, according to a preferred embodiment of the invention. For example, after the sequence signals D_I/O are fed to the gate driver 304, the gate pulse signals are generated in sequence and are fed to the first group of gate lines G1 to Gn. At this moment, the actual image data from the source driver 306 are exported to the pixels of the scanned line. At a period of time after the sequence signals D_I/O have been fed, the sequence signal DR_I/O are fed to the gate driver 304. The gate pulse signals for the black image data with respect to the second group of gate lines GR1 to GRn are sequentially generated and exported to the second group of gate lines GR1 to GRn. As shown in FIG. 6, the scanning pulses of the actual image data and the black image data relatively has a time difference. This time difference is called as the effective imaging time of the horizontal line. The quantity of the effective imaging time is depending on the impulse response of the human eye.

In FIGS. 4A and 4B, when the gate drivers 304 for the first group of gate lines G1 to Gn and the second group of gate lines GR1 to GRn are at the same side of the LC panel 302, the structure is shown in FIG. 4A. Alternatively, when the first gate driver 304a of the first group of gate lines G1 to Gn, and the second gate driver 304b of the second group of gate lines GR1 to GRn are at different sides, the structure is shown in FIG. 4B. The sequence signals D_I/O are fed to the gate driver 304a, and the sequence signals DR_I/O are fed to the gate driver 304b, then pulse signals are generated and fed to the first group of gate lines G1 to Gn and the second group of gate lines GR1 to GRn. The results are similar to the results in FIG. 4A.

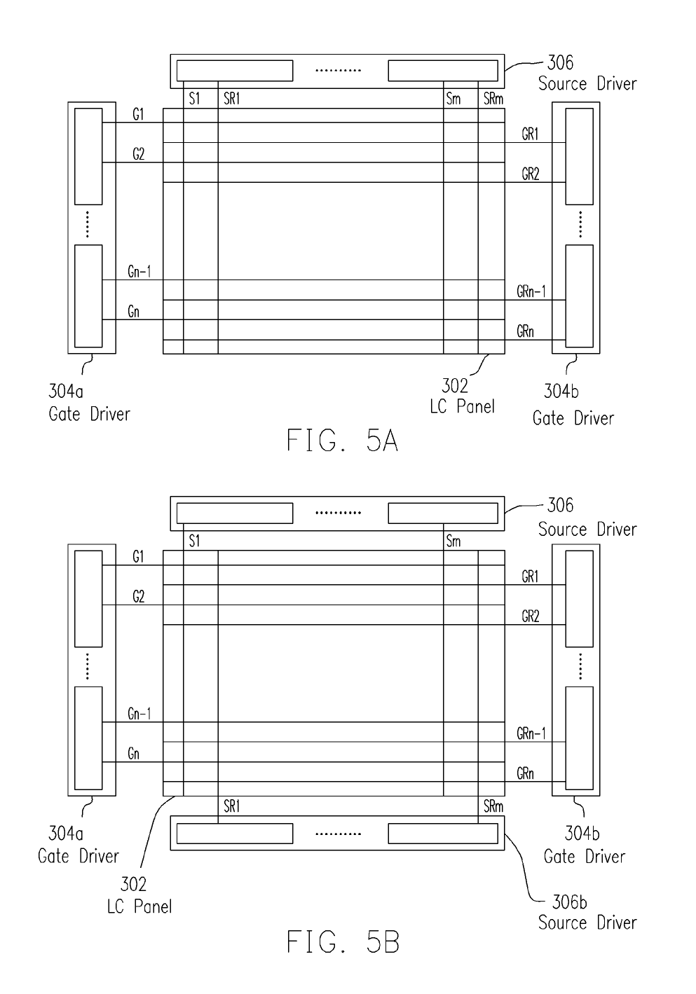

Referring to FIGS. 5A and 5B, in the embodiment, when the source drivers 306 for the first group of source lines S1 to Sm and the second group of source lines SR1 to SRm are at the same side of the LC panel 302, the structure is shown in FIG. 5A. Alternatively, when the first source driver 306a of the first group of source lines S1 to Sm, and the second source driver 306b of the second group of source lines SR1 to SRm are at different sides, the structure is shown in FIG. 5B. In FIGS. 5A and 5B, the structure that the first group of gate lines G1 to Gn and the second group of gate lines GR1 to GRn are at different sides of the LC panel 302, and the structure that the first group of gate lines G1 to Gn and the second group of gate lines GR1 to GRn are at the same sides of the LC panel 302 have the same result as shown in FIGS. 5A and 5B and the following results.

For example, when the first group of source lines S1 to Sm is used to feed with an actual image data, then the second group of source lines SR1 to SRm is used to feed with a black image data. In this manner, between at least one or multiple horizontal lines, a black image is inserted. Alternatively, it still can have the same results that the first group of source lines S1 to Sm is used to feed with a black image data and the second group of source lines SR1 to SRm is used to feed with an actual image data.

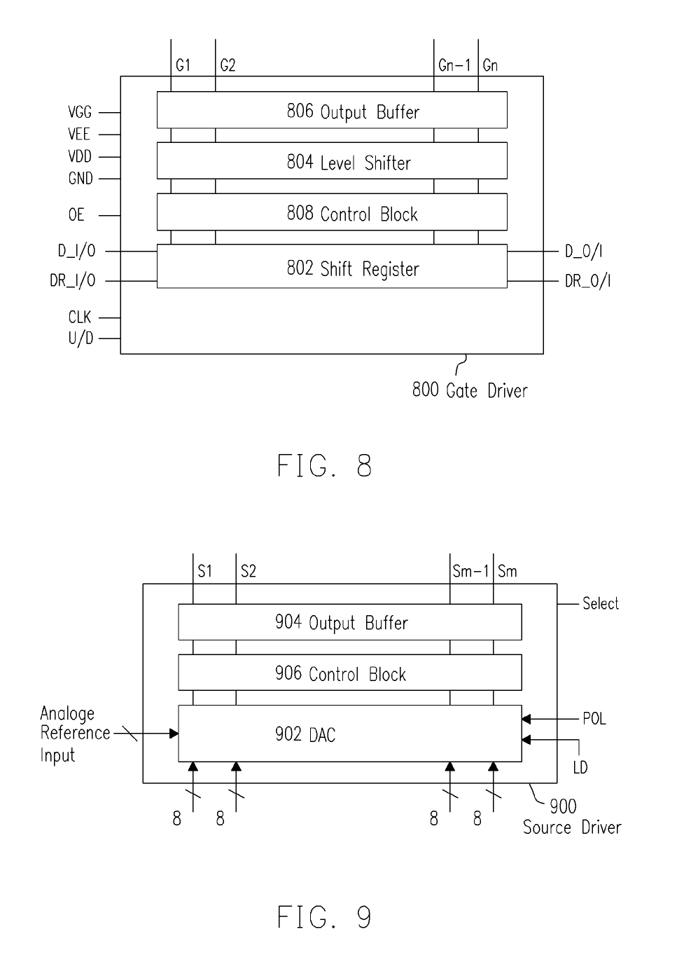

FIG. 8 is a block drawing, schematically illustrating the gate driver, according to a preferred embodiment of the invention. In FIG. 8, the foregoing gate drivers 204 and 304, the first gate drivers 204a and 304a, and the second gate drivers 204b and 304b can be a driver 800 as shown in FIG. 8. The internal functional blocks at least include a shit register 802 coupled to receive data input, which at least include the sequence signals D_I/O and DR_I/O, or even the sequence signals D_O/I and DR_O/I. A level shifter 804 is coupled to the shift register 802. An output buffer 806 is coupled to the level shifter 804 and the corresponding gate lines. In FIG. 8, the voltages VGG and VEE respectively represent the input voltages of the positive bias and negative bias for the gate lines G1 to Gn. VDD represents the input voltage for the digital circuit in the drawing. CLK represents the input clock and U/D represents the control input of up/down of the gate driver. The first group of gate lines G1 to Gn of the first gate driver 204a, as shown in FIG. 8, can also be the second group of gate lines GR1 to GRn, or the first and second groups of gate lines G1, GR1 to GR1, GRn. In the gate driver 800, it can further include a control block 808 for executing other actions.

FIG. 9 is a block drawing, schematically illustrating the source driver, according to a preferred embodiment of the invention. In FIG. 9, the foregoing source drivers 206 and 306, the first source driver 306a, and the second source driver 306b can be a driver 900 as shown in FIG. 9. The internal functional blocks include a digital to analog converter (DAC) 902 coupled to receive a reference input, and an output buffer 904 coupled to the DAC 902 and corresponding source lines S1 to Sm. The source driver can further include a control block 906 to execute other actions. POL in FIG. 9 represents a control input in electric polarity and LD represents a latching control input.

As the foregoing descriptions, the present invention is directed to a LCD panel with fast response and the driving circuit. It has been sufficient to only use TN LC or VA LC without using the OCB LC to form the LC panel. This can solve the conventional issue for needing to pre-transform the OCB LC from the splay state to the bend state to reduce the over-high driving frequency, due to the OCB LC being necessary to be used, so as to continuously produce the gray level. Also and, the conventional design needs controller for the back light module, so as to control between the actual image and the black image. The present invention can reduce several issues including the fabrication cost, the production cycle, the complexity of the LCD panel, and so on.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A liquid crystal panel, comprising:
a panel, having a plurality of pixels, wherein each one of the pixels includes a first transistor and a second transistor;
a first group of gate lines, coupled to each the first transistor at a gate electrode;
a second group of gate lines, coupled to each the second transistor at a gate electrode; and
a first group of source lines,
wherein one of the first group of gate lines and the second group of gate lines can be used to feed with gate pulse signals with respect to an actual image data and the other one can be used to with gate pulse signals with respect to a black image data.

2. The liquid crystal panel of claim 1, wherein the gate pulse signals are fed by a time difference to the first group of gate lines and the second group of gate lines.

3. The liquid crystal panel of claim 1, wherein input terminals of the first group of gate lines and the second group of gate lines are located at the same side or at the different sides of the panel.

4. The liquid crystal panel of claim 1, wherein the first group of source lines can be fed with the actual image data.

5. The liquid crystal panel of claim 1, wherein drain electrodes of the first transistor and the second transistor are coupled to a terminal of a capacitor.

6. The liquid crystal panel of claim 1, further comprising:
a second group of source lines,
wherein one of the first group of source lines and the second group of source lines can be fed with the actual image data, and the other one can be fed with the black image data.

7. The liquid crystal panel of claim 6, wherein the actual image data and the black image data are fed by a time difference.

8. The liquid crystal panel of claim 6, wherein drain electrodes of the first transistor and the second transistor are coupled to a terminal of a capacitor.

9. A driving device for a liquid crystal display (LCD) panel, the driving device comprising:
a liquid crystal (LC) panel;
a first gate driver, having a first gate circuit, coupled to the LC panel;
a second gate driver, having a second gate circuit, coupled to the LC panel; and
a first source driver, having a first source circuit, coupled to the LC panel,
wherein one of the first gate circuit and the second gate circuit can be fed with a gate pulse signal with respect to an actual image data, and the other one can be fed with a gate pulse signal with respect to a black image data.

10. The driving device of claim 9, wherein the gate pulse signals are fed by a time difference to the first gate circuit and the second gate circuit.

11. The driving device of claim 9, wherein each of the first gate driver and the second gate driver comprises:
a shift register, coupled to receive an input signal;
a level shifter, coupled to the shift register;
an output buffer, coupled to the level shifter and the corresponding gate circuit,
wherein the first gate driver and the second gate driver are located at the same side or at the different sides of the LC panel;
wherein when the first gate driver and the second gate driver are located at the same side, the first gate driver and the second gate driver can be a same one of driver or different drivers.

12. The driving device of claim 9, wherein the first source circuit can be used to feed with the actual image data.

13. The driving device of claim 9, wherein the first source driver comprises:
a digital to analog converter (DAC), coupled to receive a data input; and
an output buffer, coupled to the DAC and the first source circuit.

14. The driving device of claim 9, further comprising:
a second source driver, having a second source circuit, coupled to the LC panel;
wherein one of the first source circuit and the second source circuit can be fed with the actual image data, and the other one can be fed with the black image data.

15. The driving device of claim 14, wherein input time points for the actual image data and the black image data have a time difference.

16. The driving device of claim 14, wherein each of the first source driver and the second source driver comprises:
a digital to analog converter (DAC), coupled to receive a data input; and
an output buffer, coupled to the DAC and the first source circuit,
wherein the first source driver and the second source driver are located at the same side or at the different sides of the LC panel;
wherein when the first source driver and the second source driver are located at the same side, the first source driver and the second source driver can be a same one of driver or different drivers.
